(19) United States
(12) Patent Application Publication
(10) Pub. No.: US 2026/0149870 A1
(43) Pub. Date: May 28, 2026

(54) IMAGE PROCESSING METHOD, VIDEO PROCESSING METHOD AND ELECTRONIC DEVICE

(71) Applicant: ARASHI VISION INC., Shenzhen (CN)

(72) Inventors: Wenliang YUAN, Shenzhen (CN); Tianjiao LUO, Shenzhen (CN); Weijun ZHANG, Shenzhen (CN); Tan SU, Shenzhen (CN); Dajun HUANG, Shenzhen (CN)

(73) Assignee: ARASHI VISION INC., Shenzhen (CN)

(21) Appl. No.: 19/177,641

(22) Filed: Apr. 14, 2025

(30) Foreign Application Priority Data
Apr. 15, 2024 (CN) 202410465004.0

(51) Int. Cl. H04N 23/63; G06T 11/60; H04N 23/62

(52) U.S. Cl. CPC H04N 23/632; G06T 11/60; G06T 2200/24; H04N 23/62

(57) ABSTRACT

The present disclosure provides an image processing method, a video processing method, and electronic devices, relating to the technical field of image processing. The method may include confirming the expected angle of view of a to-be-processed image in response to detecting a user's interactive operation; and generating a target image based on the to-be-processed image and the expected angle of view of the to-be-processed image. The line feature of the target image may correspond to the expected angle of view of the to-be-processed image.

### CROSS-REFERENCE TO RELATED APPLICATION

This application claims the benefit of priority to Chinese Patent Application No. 202410465004.0, filed on Apr. 15, 2024, the entire content of which is hereby incorporated by reference in its entirety.

### BACKGROUND

The present disclosure relates to the technical field of image processing, particularly to an image processing method, a video processing method, and electronic devices.

Existing video/image editing can edit images/videos with a large angle of view into images/videos with a small angle of view. In practical applications, there may be a mismatch between the angle of view and the processing method, leading to poor display effects.

Referring to FIG. 1, taking a panoramic video as an example of a large angle of view image/video, when extracting images with a horizontal angle of view of 120° and 60°, using the omni projection method can cause distortion of lines on the left and right sides of the image.

### SUMMARY

The image processing method, video processing method, and electronic devices provided by the present disclosure can improve the display effect of the target image.

The technical solution of the present disclosure is implemented as follows:
an implementation of the present disclosure provides an image processing method, including:
confirming the expected angle of view of a to-be-processed image in response to detecting a user's interactive operation; and
generating a target image based on the to-be-processed image and the expected angle of view of the to-be-processed image, where the line feature of the target image corresponds to the expected angle of view of the to-be-processed image.

In one implementation, the expected angle of view includes a longitudinal expected angle of view, the to-be-processed image includes a first to-be-processed image, and the target image includes a first target image obtained by performing image processing on the first to-be-processed image.

When the longitudinal expected angle of view of the first to-be-processed image is not greater than a first angle of view threshold, along the vertical direction of their respective corresponding display screens, one or more first lines have greater curvature than the corresponding second lines, where the first line is a line of the first to-be-processed image, and the second line is a line of the first target image, with a corresponding relationship between the first line and the second line.

In one implementation, along the vertical direction of their respective corresponding display screens, the first line is displayed as a curve, and the second line is displayed as a vertical straight line.

In one implementation, the first to-be-processed image and the first target image have at least one or more combinations of the following features:
a plurality of first lines along the vertical direction in the first to-be-processed image are displayed as vertical second lines in the first target image;
the curvature of a plurality of first radial lines in the first to-be-processed image is consistent with the curvature of a plurality of second radial lines corresponding to the plurality of first radial lines in the first target image; and
the curvature of a curve along the horizontal direction in the first to-be-processed image is less than the curvature of a curve along the horizontal direction in the first target image.

In one implementation, the first line and the second line correspond, including: the display screen formed by the plurality of first lines is substantially the same as the display screen formed by the plurality of second lines.

In one implementation, generating the target image based on the to-be-processed image and the expected angle of view of the to-be-processed image includes:
generating the first target image based on the first to-be-processed image and a first projection method when the longitudinal expected angle of view is not greater than the first angle of view threshold,
where the first projection method causes, along the vertical direction of their respective corresponding display screens, one or more first lines to have greater curvature than the corresponding second lines.

In one implementation, the expected angle of view includes a horizontal expected angle of view, and the horizontal expected angle of view of the first to-be-processed image is greater than or equal to a second angle of view threshold.

The second angle of view threshold is greater than the first angle of view threshold.

In one implementation, the to-be-processed image includes a second to-be-processed image, and the target image includes a second target image obtained by performing image processing on the second to-be-processed image.

When the longitudinal expected angle of view of the second to-be-processed image is not less than a third angle of view threshold, the line feature of the second target image is different from the line feature of the first target image, where the third angle of view threshold is greater than or equal to the first angle of view threshold.

In one implementation, along the vertical direction of their respective corresponding display screens, one or more third lines have less curvature than the corresponding fourth lines, where the third line is a line of the second to-be-processed image, and the fourth line is a line of the second target image, with a corresponding relationship between the third line and the fourth line.

In one implementation, generating the target image based on the to-be-processed image and the expected angle of view of the to-be-processed image includes:
generating the second target image based on the second to-be-processed image and a second projection method when the longitudinal expected angle of view of the second to-be-processed image is not less than the third angle of view threshold,
where the second projection method causes, along the vertical direction of their respective corresponding display screens, one or more third lines to have less curvature than the corresponding fourth lines.

In one implementation, the method further includes:
determining an effect selected by a user when the screen is displayed in a horizontal manner, and processing the second to-be-processed image into the second target image when the effect is a crystal ball effect or a small planet effect.

In one implementation, the expected angle of view represents an angle of view corresponding to a screen in a viewfinder image for generating a target image.

In one implementation, the target image is a preview image when a capturing device captures an image; confirming the expected angle of view of the to-be-processed image in response to detecting a user's interactive operation includes:
confirming the preview screen display ratio selected by the user in response to detecting the user's interactive operation; and
confirming the expected angle of view based on the preview screen display ratio selected by the user.

In one implementation, when the ratio of the width to the height of the preview screen is a first ratio, confirming that the to-be-processed image is the first to-be-processed image, and the longitudinal expected angle of view of the first to-be-processed image is not greater than the first angle of view threshold; and
when the ratio of the width to the height of the preview screen is a second ratio, confirming that the to-be-processed image is the second to-be-processed image, and the longitudinal expected angle of view of the second to-be-processed image is not less than the third angle of view threshold, where the first ratio is greater than the second ratio.

In one implementation, the line feature includes one of the following features:
the curvature of a vertical line of the captured image in the target image; and
the curvature of a horizontal line of the captured image in the target image.

One implementation of the present disclosure also provides a video processing method, including:
generating a target video based on the to-be-processed video, where the video frames of the to-be-processed video include the to-be-processed image in the image processing method, and the video frames of the target video include the target image in the image processing method.

In some implementations, the to-be-processed video includes a first to-be-processed video segment and a second to-be-processed video segment, and the target video includes a first target video segment and a second target video segment.

The expected angle of view of the first to-be-processed video segment is different from the expected angle of view of the second to-be-processed video segment.

The line feature of the first target video segment is different from the line feature of the second target video segment.

In some implementations, generating the target video based on the to-be-processed video includes:
generating the first target video segment and the second target video segment based on the first to-be-processed video segment and the second to-be-processed video segment to smooth the transition of the first target video segment and the second target video segment.

In some implementations, the first target video segment is obtained based on the first to-be-processed video segment via a third projection method, and the third projection method causes, along the vertical direction of their respective corresponding display screens, one or more first lines to have greater curvature than the corresponding second lines.

The second target video segment is obtained based on the second to-be-processed video segment via a fourth projection method, and the fourth projection method is different from the third projection method.

In some implementations, generating the first target video segment and the second target video segment based on the first to-be-processed video segment and the second to-be-processed video segment includes:
determining the target coordinate of a plurality of sampling points in the corresponding display screen of each video frame of the first to-be-processed video segment and the second to-be-processed video segment based on the third projection method corresponding to the first to-be-processed video segment and the fourth projection method corresponding to the second to-be-processed video segment,
where the target coordinate is determined by smoothly blending the coordinates of each sampling point based on the third projection method and the fourth projection method; and
rendering the corresponding video frames based on the plurality of target coordinates, the first to-be-processed video segment, and the second to-be-processed video segment to generate the first target video segment and the second target video segment.

In some implementations, determining the target coordinate of a plurality of sampling points in the corresponding display screen of each video frame of the first to-be-processed video segment and the second to-be-processed video segment based on the third projection method corresponding to the first to-be-processed video segment and the fourth projection method corresponding to the second to-be-processed video segment includes:
determining the first coordinate of each sampling point corresponding to each video frame based on the third projection method and the to-be-processed video, and determining the second coordinate of each sampling point corresponding to each video frame based on the fourth projection method and the to-be-processed video; and
smoothly blending the first coordinate and the second coordinate for the plurality of video frames in the first to-be-processed video segment and the second to-be-processed video segment to determine the target coordinate of each sampling point corresponding to each video frame.

In some implementations, smoothly blending the first coordinate and the second coordinate for the plurality of video frames in the first to-be-processed video segment and the second to-be-processed video segment to determine the target coordinate of each sampling point corresponding to each video frame includes:
determining the first weight corresponding to each video frame based on the first ratio of the first duration to the second duration, where the first duration is the duration from the time point corresponding to each video frame to the start time point of the to-be-processed video, and the second duration is the duration from the start time point of the to-be-processed video to the end time point; and
fusing the first coordinate and the second coordinate based on the first weight to determine the target coordinate of each sampling point corresponding to each video frame.

In some implementations, smoothly blending the first coordinate and the second coordinate for the plurality of video frames in the first to-be-processed video segment and the second to-be-processed video segment to determine the target coordinate of each sampling point corresponding to each video frame includes:
determining the second weight corresponding to each video frame based on the second ratio of the ordinal position of each video frame among the plurality of video frames to the number of the plurality of video frames; and
fusing the first coordinate and the second coordinate based on the second weight to determine the target coordinate of each sampling point corresponding to each video frame.

In some implementations, determining the first coordinate of each sampling point corresponding to each video frame based on the third projection method and the to-be-processed video, and determining the second coordinate of each sampling point corresponding to each video frame based on the fourth projection method and the to-be-processed video includes:
determining the first coordinate of each sampling point corresponding to each video frame based on the first projection parameter corresponding to the third projection method and the third coordinate of each to-be-processed sampling point in the to-be-processed video; and
determining the second coordinate of each sampling point corresponding to each video frame based on the second projection parameter corresponding to the fourth projection method and each third coordinate.

In some implementations, the first target video segment includes: a first target panoramic video segment; the second target video segment includes: a second target panoramic video segment; rendering the corresponding video frames based on the plurality of target coordinates, the first to-be-processed video segment, and the second to-be-processed video segment to generate the first target video segment and the second target video segment includes:
rendering the pixel points in each video frame of the first to-be-processed video segment and the second to-be-processed video segment based on the plurality of target coordinates to obtain the corresponding first target panoramic video segment and the second target panoramic video segment.

In some implementations, before generating the target video based on the to-be-processed video, the method further includes: displaying the to-be-processed video.

In some implementations, the method further includes:
receiving a user's operation instruction for the target control of the to-be-processed video;
displaying a projection editing box in response to the operation instruction, where the projection editing box includes: multiple angle of view setting controls; and
obtaining an editing instruction based on the multiple angle of view setting controls, and determining the first to-be-processed video segment and the second to-be-processed video segment in the to-be-processed video based on the editing instruction.

In some implementations, the target video is a preview screen of a capturing device.

One implementation of the present disclosure provides an image processing device, including:
a response confirmation unit, used to confirm the expected angle of view of the to-be-processed image in response to detecting a user's interactive operation; and
an image generation unit, used to generate a target image based on the to-be-processed image and the expected angle of view of the to-be-processed image, where the line feature of the target image corresponds to the expected angle of view of the to-be-processed image.

One implementation of the present disclosure also provides a video processing device, including:
a video generation unit, used to generate a target video based on the to-be-processed video, where the video frames of the to-be-processed video include the to-be-processed image in the image processing method, and the video frames of the target video include the target image in the image processing method.

One implementation of the present disclosure also provides an electronic device, including a first memory and a first processor. The first memory stores a computer program that can run on the first processor, and the first processor executes the computer program to implement the operations in the image processing device method.

One implementation of the present disclosure also provides an electronic device, including a second memory and a second processor. The second memory stores a computer program that can run on the second processor, and the second processor executes the computer program to implement the operations in the video processing device method.

One implementation of the present disclosure also provides a computer-readable storage medium on which a computer program is stored. When the computer program is executed by the first processor, it implements the operations in the image processing device method.

One implementation of the present disclosure also provides a computer-readable storage medium on which a computer program is stored. When the computer program is executed by the second processor, it implements the operations in the video processing device method.

One implementation of the present disclosure also provides a computer program product, including a computer program. When the computer program is executed by the first processor, it implements the operations in the image processing device method.

One implementation of the present disclosure also provides a computer program product, including a computer program. When the computer program is executed by the second processor, it implements the operations in the video processing device method.

In the present disclosure implementation, confirming the expected angle of view of the to-be-processed image in response to detecting a user's interactive operation; generating a target image based on the to-be-processed image and the expected angle of view of the to-be-processed image, where the line feature of the target image corresponds to the expected angle of view of the to-be-processed image. In this way, since the target image is generated with reference to the expected angle of view of the to-be-processed image, it can make the target image match the expected angle of view, improving the display effect of the target image.

### BRIEF DESCRIPTION OF DRAWINGS

The accompanying drawings, which are incorporated herein and form part of the specification, illustrate some implementations of the present disclosure and, together with the description, further serve to explain the principles of the present disclosure and to enable a person skilled in the pertinent art to make and use the present disclosure.

FIG. 1 is a schematic diagram of a projection effect in the related art according to an implementation of the present disclosure.

FIG. 2 is a flowchart of the image processing method according to an implementation of the present disclosure.

FIG. 3 is a flowchart of the image processing method according to an implementation of the present disclosure.

FIG. 4 is an effect diagram of the image processing method according to an implementation of the present disclosure.

FIG. 5 is an effect diagram of the image processing method according to an implementation of the present disclosure;

FIG. 6 is a flowchart of the image processing method according to an implementation of the present disclosure.

FIG. 7 is a flowchart of the image processing method according to an implementation of the present disclosure;

FIG. 8 is a flowchart of the image processing method according to an implementation of the present disclosure.

FIG. 9 is an effect diagram of the image processing method according to an implementation of the present disclosure.

FIG. 10 is a flowchart of the image processing method according to an implementation of the present disclosure.

FIG. 11 is a flowchart of the image processing method according to an implementation of the present disclosure.

FIG. 12 is a flowchart of the image processing method according to an implementation of the present disclosure.

FIG. 13 is a flowchart of the video processing method according to an implementation of the present disclosure.

FIG. 14 is a flowchart of the video processing method according to an implementation of the present disclosure.

FIG. 15 is a flowchart of the video processing method according to an implementation of the present disclosure.

FIG. 16 is a flowchart of the video processing method according to an implementation of the present disclosure.

FIG. 17 is a flowchart of the video processing method according to an implementation of the present disclosure.

FIG. 18 is a flowchart of the video processing method according to an implementation of the present disclosure.

FIG. 19 is a flowchart of the video processing method according to an implementation of the present disclosure.

FIG. 20 is a flowchart of the video processing method according to an implementation of the present disclosure;

FIG. 21 is a flowchart of the video processing method according to an implementation of the present disclosure;

FIG. 22 is a flowchart of the video processing method according to an implementation of the present disclosure.

FIG. 23 is an effect diagram of the video processing method according to an implementation of the present disclosure.

FIG. 24 is a schematic structural diagram of the image processing device according to an implementation of the present disclosure.

FIG. 25 is a schematic diagram of a hardware entity of an electronic device according to an implementation of the present disclosure.

FIG. 26 is a schematic structural diagram of the video processing device according to an implementation of the present disclosure.

FIG. 27 is a schematic diagram of a hardware entity of an electronic device according to an implementation of the present disclosure. Some implementations of the present disclosure will be described with reference to the accompanying drawings.

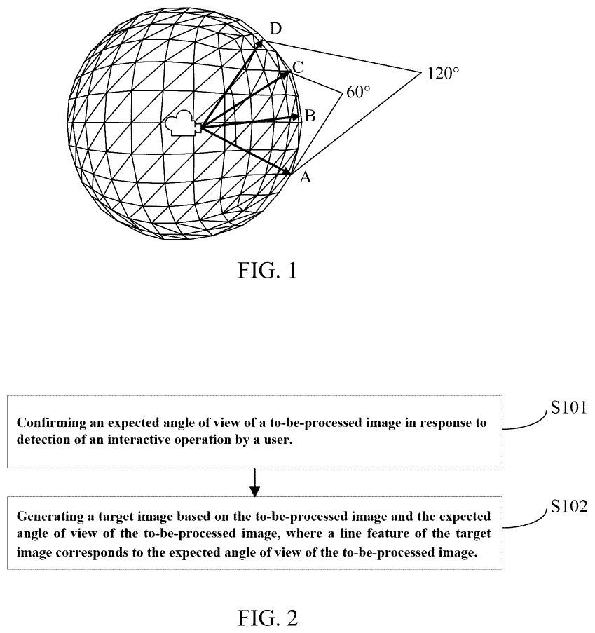

### DETAILED DESCRIPTION

To make the objectives, technical solutions, and advantages of the present disclosure clearer, the following provides a more detailed description of the technical solutions of the present disclosure in conjunction with the accompanying drawings and implementations. The described implementations should not be considered as limitations to the present disclosure. All other implementations obtained by those skilled in the art without creative efforts fall within the scope of the present disclosure.

In the following description, references to “some implementations” describe a subset of all possible implementations. It should be understood that “some implementations” may refer to the same or different subsets of all possible implementations and can be combined with each other without conflict.

If the application documents contain similar descriptions of “first/second,” the following explanation is added: in the following description, the terms “first/second/third” are merely used to distinguish similar objects and do not represent a specific order for the objects. It is understood that “first/second/third” can interchange specific sequences or orders where permissible, so that some implementations of the present disclosure described here can be implemented in an order other than illustrated or described here.

Unless otherwise defined, all technical and scientific terms used herein have the same meaning as commonly understood by one of ordinary skill in the art to which the present disclosure belongs. The terms used herein are intended to describe some implementations of the present disclosure and are not intended to limit the present disclosure.

This application provides an image processing method. Please refer to FIG. 2, which is a flowchart of the image processing method provided by the present disclosure. The method includes:

S101. Confirming an expected angle of view of a to-be-processed image in response to detection of an interactive operation by a user.

In some implementations of the present disclosure, the image processing device can obtain a user's interactive operation instruction for the to-be-processed image based on a human-machine interaction device and determine the expected angle of view for the to-be-processed image based on the interactive operation instruction. The expected angle of view may include a longitudinal expected angle of view and a horizontal expected angle of view.

The image processing device can be any one of a camera, terminal, mobile terminal, or server with corresponding image processing functions.

In some other implementations, the image processing device can determine the corresponding expected angle of view based on the user's display requirements for the to-be-processed image obtained through a human-machine interaction device. The display requirements may include any one of the following: the display screen ratio for the to-be-processed image, the display effects for the to-be-processed image, or the ratio of height to width of the display screen for the to-be-processed image.

S102. Generating a target image based on a to-be-processed image and an expected angle of view of the to-be-processed image, where a line feature of the target image corresponds to the expected angle of view of the to-be-processed image.

In some implementations of the present disclosure, the image processing device projects the to-be-processed image into a target image that conforms to the expected angle of view based on the expected angle of view. The line feature of the target image corresponding to the expected angle of view aligns.

The line feature may include any one of the following: the curvature of a vertical line of a captured image in the target image; the curvature of a horizontal line of the captured image in the target image; and the curvature of a radial line of the captured image in the target image. Any one of the vertical line, horizontal line, and radial line in the target image generated with the same expected angle of view corresponds.

In some other implementations, the image processing device can determine a projection method that can be used to obtain an image projection with the expected angle of view based on the expected angle of view for the to-be-processed image, and project the pixel points in the to-be-processed image onto the display screen based on the determined projection method to generate the target image.

In some implementations of the present disclosure, since the target image is generated with reference to the expected angle of view of the to-be-processed image, it can make the target image match the expected angle of view, eliminating the mismatch between the angle of view and the projected image, thereby improving the display effect of the target image.

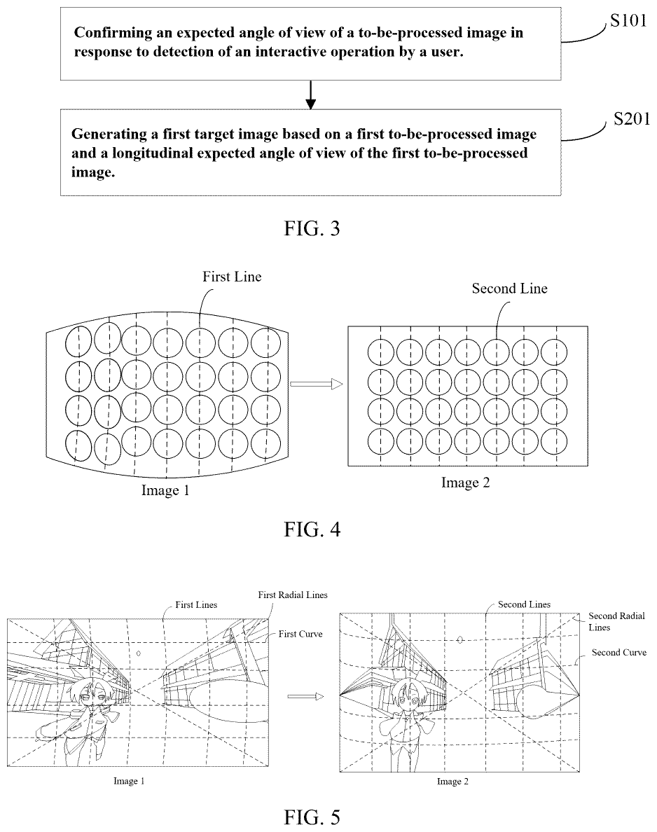

Please refer to FIG. 3, which is a flowchart of the image processing method provided by the present disclosure. S102 shown in FIG. 2 can also be implemented through S201, and the method includes:

S201. Generating a first target image based on a first to-be-processed image and a longitudinal expected angle of view of the first to-be-processed image.

In some implementations of the present disclosure, the expected angle of view includes a longitudinal expected angle of view, the to-be-processed image includes a first to-be-processed image, and the target image includes a first target image obtained by performing image processing on the first to-be-processed image. When the image processing device determines that the longitudinal expected angle of view of the first to-be-processed image is not greater than a first angle of view threshold, the image processing device can process the first to-be-processed image so that one or more first lines along the vertical direction of the corresponding display screen in the first to-be-processed image become second lines with reduced curvature along the vertical direction of the corresponding display screen in the first target image, thereby forming a first target image projected on the display screen. The first line is a line of the first to-be-processed image, and the second line is a line of the first target image. The display screen formed by the plurality of first lines is substantially the same as the display screen formed by the plurality of second lines, that is, the display screen of the first to-be-processed image is substantially the same as the display screen of the first target image.

In some implementations of the present disclosure, the image processing device can determine a projection method that conforms to the longitudinal expected angle of view and project the pixel points in the first to-be-processed image onto the display screen based on the determined projection method to generate the first target image. This makes the first line displayed as a curve and the second line displayed as a vertical straight line along the vertical direction of their respective corresponding display screens.

In some implementations, referring to FIG. 4, image 1 can be the first to-be-processed image displayed on the display screen, and image 2 can be the first target image displayed on the display screen. The curve (first line) along the vertical direction in image 1, after being projected by the projection method, results in the vertical straight line (second line) displayed in image 2. Referring to FIG. 3, it can be seen that the display screens of image 1 and image 2 are substantially the same.

In some other implementations, the first to-be-processed image and the first target image have at least one or a combination of the following features: a plurality of first lines along the vertical direction in the first to-be-processed image are displayed as vertical second lines in the first target image; the curvature of a plurality of first radial lines in the first to-be-processed image is consistent with the curvature of a plurality of second radial lines corresponding to the plurality of first radial lines in the first target image; and the curvature of a curve along the horizontal direction in the first to-be-processed image is less than the curvature of a curve along the horizontal direction in the first target image.

In some implementations, referring to FIG. 5, image 1 can be the first to-be-processed image displayed on the display screen, and image 2 can be the first target image displayed on the display screen. A plurality of curves (first lines) along the vertical direction in the first to-be-processed image in image 1 are displayed as vertical straight lines (second lines) in image 2 after being projected by the corresponding projection method. The curvature of a plurality of first radial lines in the first to-be-processed image in image 1 is consistent with the curvature of a plurality of second radial lines displayed in image 2. The curvature of a curve (first curve) along the horizontal direction in the first to-be-processed image in image 1 is less than the curvature of a curve (second curve) along the horizontal direction displayed in image 2.

In some implementations of the present disclosure, the image processing device can process the first to-be-processed image so that one or more first lines along the vertical direction of the display screen in the first to-be-processed image become second lines with reduced curvature after processing, thereby forming a first target image projected on the display screen. In this way, when the obtained longitudinal angle of view is not greater than the first angle of view threshold, the first to-be-processed image is projected as the first target image, which can make the first target image's display more in line with the user's projection expectations compared to using only one projection method in the related technology. Moreover, the first lines in the first to-be-processed image, after being processed by the image processing device, are displayed as second lines with smaller curvature in the first target image, reducing the distortion of the image along the vertical direction and improving the display effect of the first target image.

In some implementations of the present disclosure, a plurality of first lines along the vertical direction in the first to-be-processed image are displayed as vertical second lines in the first target image, and the curvature of a first radial line in the first to-be-processed image is consistent with the curvature of a second radial line in the first target image, and the curvature of a curve along the horizontal direction in the first to-be-processed image is less than the curvature of a curve along the horizontal direction in the first target image. In this way, after the first to-be-processed image is processed by the image processing device, the first lines along the vertical direction are displayed as second lines with smaller curvature in the first target image, and the curvature of a first radial line in the to-be-processed image is consistent with the curvature of a second radial line in the first target image, which can ensure that while reducing the curvature of the first to-be-processed image in the vertical direction, the distortion degree of the radial image in the first target image is also reduced.

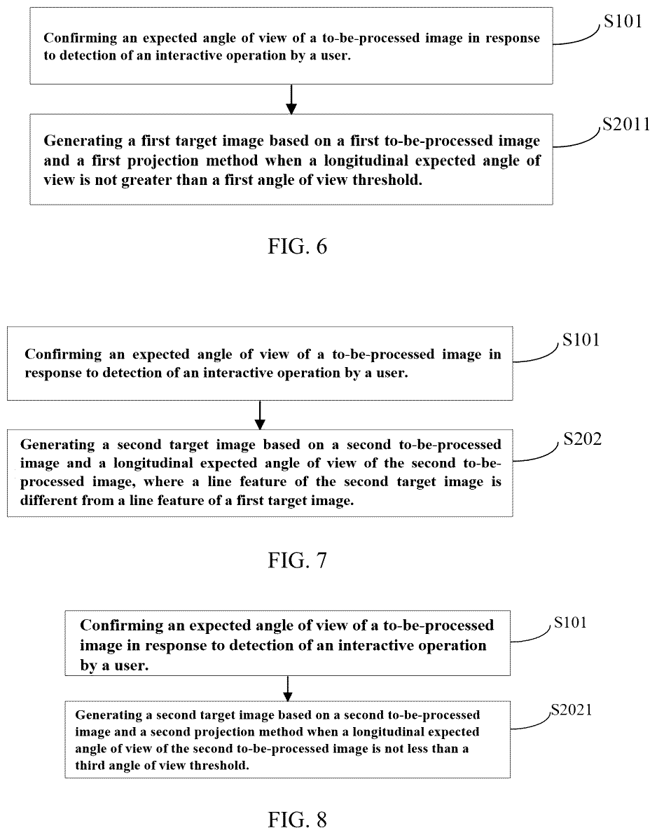

Please refer to FIG. 6, which is a flowchart of the image processing method provided by the present disclosure. S201 shown in FIG. 3 can also be implemented through S2011, and the method includes:

S2011. Generating a first target image based on a first to-be-processed image and a first projection method when a longitudinal expected angle of view is not greater than a first angle of view threshold.

In some implementations of the present disclosure, the image processing device obtains the user's longitudinal expected angle of view for the first target image. When the longitudinal expected angle of view is not greater than the first angle of view threshold, the first projection method that can project an image with the corresponding angle of view is determined based on the longitudinal expected angle of view, and the pixel points in the first to-be-processed image are projected onto the display screen based on the first projection method to generate the first target image.

The first projection method causes, along the vertical direction of the respective corresponding display screens of the first to-be-processed image and the first target image, one or more first lines to have a greater curvature than the corresponding second lines.

In some other implementations, the image processing device can also display an angle of view selection control for the to-be-processed image, and obtain the longitudinal expected angle of view through this angle of view selection control. If the longitudinal expected angle of view is not greater than the first angle of view threshold, the corresponding first projection method is determined based on the longitudinal expected angle of view, and the pixel points in the first to-be-processed image are projected onto the display screen based on the determined first projection method to generate the first target image.

In some other implementations, the expected angle of view may also include a horizontal expected angle of view. When the image processing device determines that the longitudinal expected angle of view of the first to-be-processed image is not greater than the first angle of view threshold and the horizontal expected angle of view is greater than or equal to the second angle of view threshold, the image processing device projects the first to-be-processed image to generate the first target image based on the first to-be-processed image and the longitudinal and horizontal expected angles of view. The second angle of view threshold is greater than the first angle of view threshold.

In some other implementations, the first projection method can be the Panini projection. The first projection method can also be other projection methods, and the present disclosure does not specifically limit it.

In some implementations of the present disclosure, the image processing device can project the pixel points in the to-be-processed image onto the display screen using the Panini projection method to generate the target image. The Panini projection method is a mathematical projection function for mapping image transformations, referred to as Panini projection. Panini projection can be the basis for the software panoramic viewer Panini. Panini projection can stitch several photos together to form a panoramic image view. Panini projection can even alter photos taken with a fisheye lens to make them appear “normal.” Panini projection is already included in open-source panoramic image stitching programs such as Hugin and PTGui. In Panini projection, vertical straight lines in the real world remain straight and vertical in the image. Similarly, radial lines are not deformed during processing; however, horizontal lines become curved.

In some implementations of the present disclosure, when the longitudinal expected angle of view is not greater than the first angle of view threshold, the first target image is generated based on the first to-be-processed image and the first projection method. The first projection method causes, along the vertical direction of the respective corresponding display screens, one or more first lines to have a greater curvature than the corresponding second lines. In this way, in the process of processing the first to-be-processed image into the first target image, the curvature of the lines in the vertical direction of the first to-be-processed image is reduced, making the curvature of the first target image's display along the vertical direction decrease, thereby improving the display effect of the first target image.

Please refer to FIG. 7, which is a flowchart of the image processing method provided by the present disclosure. S102 shown in FIG. 2 can also be implemented through S202, and the method includes:

S202. Generating a second target image based on a second to-be-processed image and a longitudinal expected angle of view of the second to-be-processed image, where a line feature of the second target image is different from a line feature of a first target image.

In some implementations of the present disclosure, the to-be-processed image includes a second to-be-processed image, and the target image includes a second target image obtained by processing the second to-be-processed image. When the longitudinal expected angle of view obtained by the image processing device is not less than the third angle of view threshold, the image processing device can perform projection processing on the second to-be-processed image to generate the second target image, and the line feature of the second target image is different from the line feature of the first target image. The third angle of view threshold is greater than or equal to the first angle of view threshold.

The difference in line features between the second target image and the first target image may include one or more of the following: the curvature of a vertical line of the captured image in the first target image is different from the curvature of the vertical line of the captured image in the second target image; the curvature of a corresponding horizontal line of the captured image in the first target image is different from the curvature of the corresponding horizontal line of the captured image in the second target image; the curvature of a corresponding radial line of the captured image in the first target image is different from the curvature of the corresponding radial line of the captured image in the second target image.

In some other implementations, the image processing device projects the pixel points in the second to-be-processed image to generate the second target image based on the second to-be-processed image and the longitudinal expected angle of view of the second to-be-processed image. This makes the curvature of one or more third lines along the vertical direction of the respective corresponding display screens of the second to-be-processed image and the second target image less than the curvature of the corresponding fourth lines; the third line is a line of the second to-be-processed image, and the fourth line is a line of the second target image, and the third line and the fourth line have a corresponding relationship. The display screen formed by the plurality of third lines is substantially the same as the display screen formed by the plurality of fourth lines, that is, the display screen of the second to-be-processed image is substantially the same as the display screen of the second target image.

In some implementations of the present disclosure, the second target image is generated based on the second to-be-processed image and the longitudinal expected angle of view of the second to-be-processed image, and the line feature of the second target image is different from the line feature of the first target image. Since the second target image is generated based on the user's longitudinal expected angle of view, compared to the related technology where the same projection method is used regardless of the angle of view size, the projection effect can meet the user's expectations and improve the display effect of the second target image.

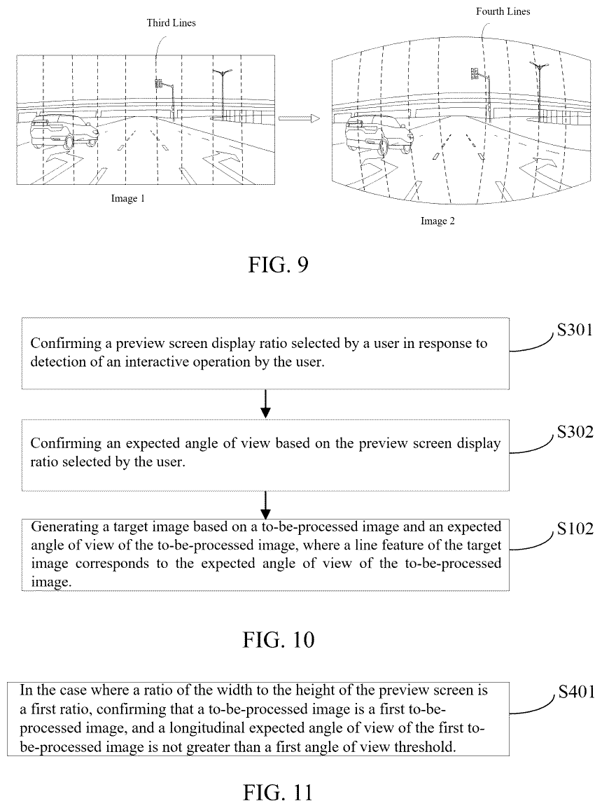

Please refer to FIG. 8, which is a flowchart of the image processing method provided by the present disclosure. S202 shown in FIG. 7 can also be implemented through S2021, and the method includes:

S2021. Generating a second target image based on a second to-be-processed image and a second projection method when a longitudinal expected angle of view of the second to-be-processed image is not less than a third angle of view threshold.

In some implementations of the present disclosure, the image processing device determines that the obtained longitudinal expected angle of view is not less than the third angle of view threshold, and then determines the corresponding second projection method based on the longitudinal expected angle of view. The pixel points in the second to-be-processed image are projected onto the display screen based on the second projection method to obtain the second target image. The second projection method causes, along the vertical direction of the respective corresponding display screens of the second to-be-processed image and the second target image, one or more third lines to have less curvature than the corresponding fourth lines.

In some implementations, referring to FIG. 9, image 1 can be the second to-be-processed image displayed on the display screen, and image 2 can be the second target image displayed on the display screen. The third lines along the vertical direction in image 1, after being projected by the image processing device combined with the second projection method, result in fourth lines with greater curvature displayed in image 2.

The second projection method can be an Omnidirectional projection method. In other implementations, the second projection method can also be other projection methods different from the first projection method. The Omnidirectional projection method can simulate the imaging process of a pinhole camera, as well as simulate the imaging process of wide-angle and fisheye camera models (Unified camera model). However, the Omnidirectional projection method does not completely simulate the distortion process and needs to be combined with other distortion models. The essence of the fisheye camera model is to move the original optical center along the optical axis direction to obtain a virtual optical center, thereby achieving the purpose of simulating distortion.

In some implementations of the present disclosure, when the longitudinal expected angle of view of the second to-be-processed image is not less than the third angle of view threshold, the second target image is generated based on the second to-be-processed image and the second projection method, where the second projection method causes, along the vertical direction of the display screen, one or more third lines to have less curvature than the corresponding fourth lines. In this way, the second target image obtained based on the second projection method has greater curvature in the vertical direction than the second to-be-processed image, making the second target image projected on the display screen more in line with the user's expectation of a larger longitudinal expected angle of view, thereby improving the display effect of the second target image.

S2021 can also be implemented through S2022, and the method includes:

S2022. Determining an effect selected by a user when a screen is displayed in a horizontal manner, and processing the second to-be-processed image into the second target image when the effect is a crystal ball effect or a small planet effect.

In some implementations of the present disclosure, the image processing device can obtain the user's display method for the second to-be-processed image. When the user selects horizontal display, the image processing device can also display multiple functional effect controls for the second to-be-processed image. The functional effect controls may include a crystal ball effect control and a small planet effect control. If the user clicks the crystal ball effect control or the small planet effect control, the pixel points in the second to-be-processed image are projected onto the display screen based on the second projection method combined with the corresponding effect to generate the second target image.

When the image processing device obtains the user's display method for the second to-be-processed image, it includes one of the following: horizontal display, 16:9 display, stretch display, or widescreen display, determining the case where the user selects horizontal display.

In some implementations of the present disclosure, determining an effect selected by a user when a screen is displayed in a horizontal manner, and processing the second to-be-processed image into the second target image when the effect is a crystal ball effect or a small planet effect. Since the curvature of the lines along the vertical direction in the second target image is larger, that is, the curvature of the second target image along the vertical direction is larger, after projecting the second target image with the crystal ball effect or the small planet effect, the projected image is more in line with the corresponding image effect.

Please refer to FIG. 10, which is a flowchart of the image processing method provided by the present disclosure. S101 shown in FIG. 2 can also be implemented through S301 to S302, and the method includes:

S301. Confirming a preview screen display ratio selected by a user in response to detection of an interactive operation by the user.

In some implementations of the present disclosure, the image processing device can obtain the user's interactive operation instruction based on a human-machine interaction device and determine the preview screen display ratio selected by the user based on the interactive operation instruction.

The interactive operation instruction can be an operation instruction for each preview screen display ratio. The user clicks a certain preview screen display ratio to determine the corresponding preview screen display ratio.

S302. Confirming an expected angle of view based on the preview screen display ratio selected by the user.

In some implementations of the present disclosure, the image processing device can confirm the expected angle of view based on the determined preview screen display ratio, determine the corresponding projection method based on the expected angle of view, and project the pixel points in the to-be-processed image onto the display screen based on the projection method to obtain the target image. The target image is a preview image when a capturing device captures an image.

The expected angle of view represents an angle of view corresponding to a screen in a viewfinder image for generating a target image.

In some implementations, referring to Table 1, the preview screen display ratio can include: 9:16, 16:9, 1:1, 2.35:1, 4:3, and 3:4. If the user selects a 9:16 display ratio, it is determined that the corresponding longitudinal expected angle of view is not less than the third angle of view threshold, and the corresponding second projection method can be determined as the Omnidirectional projection method. After the user selects the 9:16 display ratio, the image processing device can perform megaView, UltraWide, and Dewarp projections based on the Omnidirectional projection method. If the user selects a 16:9 display ratio, it is determined that the corresponding longitudinal expected angle of view is not greater than the first angle of view threshold, and the corresponding first projection method can be determined as the Panini projection method. After the user selects the 16:9 display ratio, the image processing device can perform megaView, UltraWide, and Dewarp projections based on the Panini projection method. If the user selects a 1:1 display ratio, it is determined that the corresponding longitudinal expected angle of view is not less than the third angle of view threshold, and the corresponding second projection method can be determined as the Omnidirectional projection method. After the user selects the 1:1 display ratio, the image processing device can perform megaView, UltraWide, and Dewarp projections based on the Omnidirectional projection method. If the user selects a 2.35:1 display ratio, it is determined that the corresponding longitudinal expected angle of view is not greater than the first angle of view threshold, and the corresponding first projection method can be determined as the Panini projection method. After the user selects the 2.35:1 display ratio, the image processing device can perform megaView, UltraWide, and Dewarp projections based on the Panini projection method. If the user selects a 4:3 display ratio, it is determined that the corresponding longitudinal expected angle of view is not less than the third angle of view threshold, and the corresponding second projection method can be determined as the Omnidirectional projection method. After the user selects the 4:3 display ratio, the image processing device can perform megaView, UltraWide, and Dewarp projections based on the Omnidirectional projection method. If the user selects a 3:4 display ratio, it is determined that the corresponding longitudinal expected angle of view is not less than the third angle of view threshold, and the corresponding second projection method can be determined as the Omnidirectional projection method. After the user selects the 3:4 display ratio, the image processing device can perform megaView, UltraWide, and Dewarp projections based on the Omnidirectional projection method. Additionally, when the user needs to perform Tiny Planet projection, only the Omnidirectional projection method can be used for projection.

TABLE 1

| | ratio | | | | | |
|---|---|---|---|---|---|---|
| Viewing angles | 9:16 | 16:9 | 1:1 | 2.35:1 | 4:3 | 3:4 |
| Tiny Planet | Omni | | | | | |
| mega View | Omni | Panini | Omni | Panini | Omni | Omni |
| Ultra Wide | Omni | Panini | Omni | Panini | Omni | Omni |
| Dewarp | Omni | Panini | Omni | Panini | Omni | Omni |

In some implementations of the present disclosure, in response to detecting a user's interactive operation, the preview screen display ratio selected by the user is confirmed. Based on the preview screen display ratio selected by the user, the expected angle of view is confirmed. In this way, after obtaining the preview screen display ratio selected by the user, the expected angle of view under this display ratio can be determined, and then the to-be-processed image is projected using the expected angle of view. Compared to the related technology where different images are projected using the same projection method, this solves the problem of a single image projection angle of view, allowing the projection effect to meet the user's expectations.

Please refer to FIG. 11, which is a flowchart of the image processing method provided by the present disclosure. The method includes:

S401. In the case where a ratio of the width to the height of a preview screen is a first ratio, confirming that a to-be-processed image is a first to-be-processed image, and a longitudinal expected angle of view of a first to-be-processed image is not greater than a first angle of view threshold.

In some implementations of the present disclosure, after obtaining the display ratio of the preview screen selected by the user, the image processing device can also determine whether the to-be-processed image is a first to-be-processed image or a second to-be-processed image based on the ratio of the width to the height in the display ratio of the preview screen. When the ratio of the width to the height of the preview screen is the first ratio, it is confirmed that the to-be-processed image is the first to-be-processed image, and the longitudinal expected angle of view of the first to-be-processed image is not greater than the first angle of view threshold.

In some implementations, when the ratio of the width to the height in the display ratio of the preview screen is 16:9 or 2.35:1, it is confirmed that the to-be-processed image is the first to-be-processed image.

In some implementations of the present disclosure, when the ratio of the width to the height of the screen is the first ratio, it is confirmed that the to-be-processed image is the first to-be-processed image, and the longitudinal expected angle of view of the first to-be-processed image is not greater than the first angle of view threshold. Since the first ratio is greater than the second ratio, it can be determined that when the user selects a larger width-to-height ratio, the first to-be-processed image can be projected as a first target image with a smaller width-to-height ratio. In this way, the longitudinal expected angle of view of the first target image obtained by projection also better matches the user's expectation of the first ratio, improving the display effect of the first target image.

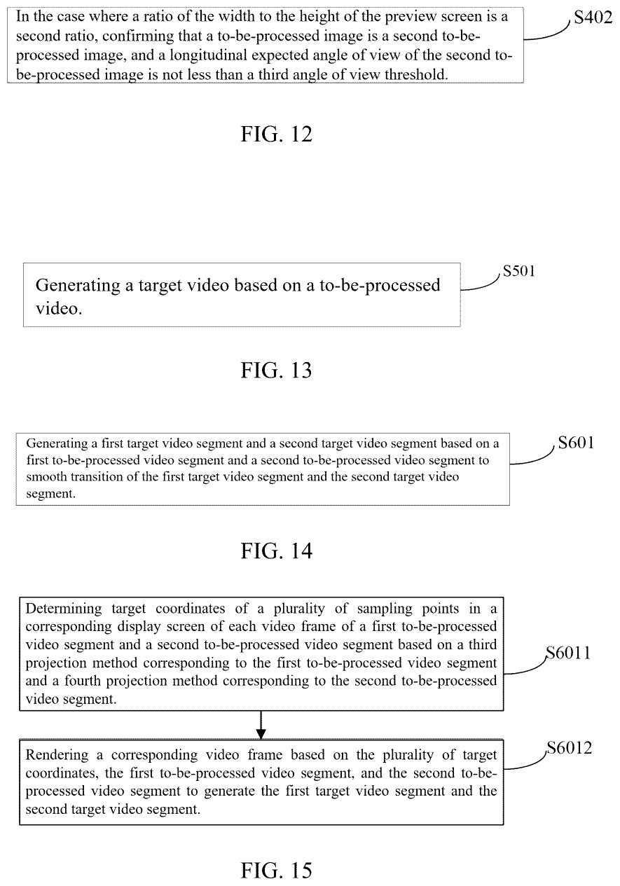

Please refer to FIG. 12, which is a flowchart of the image processing method provided by the present disclosure. The method includes:

S402. In the case where a ratio of the width to the height of the preview screen is a second ratio, confirming that a to-be-processed image is a second to-be-processed image, and a longitudinal expected angle of view of the second to-be-processed image is not less than a third angle of view threshold.

In some implementations of the present disclosure, when the ratio of the width to the height of the preview screen is the second ratio, it is confirmed that the to-be-processed image is the second to-be-processed image, and the longitudinal expected angle of view of the second to-be-processed image is not less than the third angle of view threshold.

The first ratio is greater than the second ratio. In some implementations, when the ratio of the width to the height in the display ratio of the preview screen is any one of 9:16, 1:1, 4:3, and 3:4, it is confirmed that the to-be-processed image is the second to-be-processed image.

In some implementations of the present disclosure, when the ratio of the width to the height of the screen is the second ratio, it is confirmed that the to-be-processed image is the second to-be-processed image, and the longitudinal expected angle of view of the second to-be-processed image is not less than the third angle of view threshold. Since the first ratio is greater than the second ratio, it can be determined that when the user selects a smaller width-to-height ratio, the second to-be-processed image can be projected as a second target image with a smaller width-to-height ratio. In this way, the longitudinal expected angle of view of the second target image obtained by projection also better matches the user's expectation of the second ratio, improving the display effect of the second target image.

Please refer to FIG. 13, which is a flowchart of the video processing method provided by the present disclosure. The method includes:

S501. Generating a target video based on a to-be-processed video.

In some implementations of the present disclosure, the image processing device, in response to detecting a user's interactive operation, determines the expected angle of view of the to-be-processed video. Based on the to-be-processed video and the expected angle of view, the to-be-processed video is projected as the target video. The line feature of the target video corresponding to the expected angle of view aligns.

The to-be-processed video includes a first to-be-processed video segment and a second to-be-processed video segment, and the target video includes a first target video segment and a second target video segment. The expected angle of view of the first to-be-processed video segment is different from the expected angle of view of the second to-be-processed video segment. The image processing device obtains the user's different respective expected angles of view for the first to-be-processed video segment and the second to-be-processed video segment, and based on the different expected angles of view corresponding to the first to-be-processed video segment and the second to-be-processed video segment, the first to-be-processed video segment and the second to-be-processed video segment are projected on the display screen to generate the first target video segment and the second target video segment. The line feature of the first target video segment is different from the line feature of the second target video segment.

The difference in line features between the first target video segment and the second target video segment may include one or more of the following: vertical lines of the captured image corresponding to different expected angles of view, with different curvatures in the first target video segment and the second target video segment; horizontal lines of the captured image corresponding to different expected angles of view, with different curvatures in the first target video segment and the second target video segment; and radial lines of the captured image corresponding to different expected angles of view, with different curvatures in the first target video segment and the second target video segment.

In some other implementations, the image processing device can determine a projection method that can be used to obtain an image projection with the corresponding expected angle of view based on the expected angle of view for the first to-be-processed video segment, and project each video frame in the first to-be-processed video segment onto the display screen based on the determined projection method to generate the first target video segment. The image processing device can determine a projection method that can be used to obtain an image projection with the corresponding expected angle of view based on the expected angle of view for the second to-be-processed video segment, and project each video frame in the second to-be-processed video segment onto the display screen based on the determined projection method to generate the second target video segment.

In some other implementations, the first target video segment is obtained based on the first to-be-processed video segment via a third projection method, and the third projection method causes, along the vertical direction of the respective corresponding display screens of the first to-be-processed video segment and the first target video segment, one or more first lines to have greater curvature than the corresponding second lines; and the second target video segment is obtained based on the second to-be-processed video segment via a fourth projection method, and the fourth projection method is different from the third projection method.

In some other implementations, the target video segment can be a preview screen of a capturing device. The image processing device can be a capturing device, and after obtaining the to-be-processed video, the capturing device can process the to-be-processed video segment into the corresponding target video segment for preview.

In some implementations of the present disclosure, the user's respective expected angles of view for the first to-be-processed video segment and the second to-be-processed video segment are obtained, and based on the different expected angles of view corresponding to the first to-be-processed video segment and the second to-be-processed video segment, the first to-be-processed video segment and the second to-be-processed video segment are projected on the display screen to generate the first target video segment and the second target video segment. The line feature of the first target video segment is different from the line feature of the second target video segment. Since the first target video segment and the second target video segment are generated based on the user's expected angles of view, and the line features in the first target video segment and the second target video segment corresponding to different expected angles of view are different, the video corresponding to different expected angles of view has different projection screens. Therefore, compared to the related technology where the same projection method is used regardless of the angle of view size, the projection screen can better meet the user's expectations, improving the display effect of the first target video segment and the second target video segment.

Please refer to FIG. 14, which is a flowchart of the video processing method provided by the present disclosure. S501 shown in FIG. 13 can also be implemented through S601, and the method includes:

S601. Generating a first target video segment and a second target video segment based on a first to-be-processed video segment and a second to-be-processed video segment to smooth transition of the first target video segment and the second target video segment.

In some implementations of the present disclosure, since the expected angles of view corresponding to the first to-be-processed video segment and the second to-be-processed video segment are different, if the projection is performed according to the different projection methods corresponding to the first to-be-processed video segment and the second to-be-processed video segment, the first target video segment cannot smoothly transition to the second target video segment. To solve this problem, the image processing device projects each video frame in the first to-be-processed video segment and the second to-be-processed video segment using a smooth transition scheme for sampling points in the display screen, thereby obtaining the smoothly transitioned first target video segment and second target video segment.

When projecting multiple video frames, the closer a video frame is to the first video frame of the first to-be-processed video segment, the greater the proportion of the third projection method used for that video frame is. The closer a video frame is to the last video frame of the second to-be-processed video segment, the greater the proportion of the fourth projection method used for that video frame is.

In some implementations of the present disclosure, the first target video segment and the second target video segment are generated based on the transition processing, the first to-be-processed video segment, and the second to-be-processed video segment to smooth the transition of the first target video segment and the second target video segment. In this way, when projecting videos with different expected angles of view, the videos with different expected angles of view can smoothly transition without large changes in the video angle of view or video screen on the display screen.

Please refer to FIG. 15, which is a flowchart of the video processing method provided by the present disclosure. S601 shown in FIG. 14 can also be implemented through S6011 to S6012, and the method includes:

S6011. Determining target coordinate of a plurality of sampling points in a corresponding display screen of each video frame of a first to-be-processed video segment and a second to-be-processed video segment based on a third projection method corresponding to the first to-be-processed video segment and a fourth projection method corresponding to the second to-be-processed video segment.

In some implementations of the present disclosure, the image processing device can import the to-be-processed video into video editing software. During the playback of the video screen, if the user needs to project a certain segment of the video with an expected angle of view, they can select and determine the first to-be-processed video segment and the second to-be-processed video segment on the time progress bar. When the user determines the first to-be-processed video segment and the second to-be-processed video segment, the image processing device can determine the third projection method corresponding to the first to-be-processed video segment and the fourth projection method corresponding to the second to-be-processed video segment based on the obtained longitudinal expected angle of view. The image processing device determines the coordinates of each sampling point in the corresponding display screen based on the third projection method, and then determines the coordinates of each sampling point in the corresponding display screen based on the fourth projection method. The two coordinates are smoothly blended for multiple frames in the first to-be-processed video segment and the second to-be-processed video segment to determine the target coordinate of each sampling point corresponding to each video frame. The target coordinate is determined by smoothly blending the coordinates of each sampling point based on the third projection method and the fourth projection method.

In some other implementations, if the user wants to render the to-be-processed video into a panoramic target video, the sampling point coordinates corresponding to the third projection method and the sampling point coordinates corresponding to the fourth projection method are smoothly blended into the spherical coordinate system for multiple video frames in the first to-be-processed video segment and the second to-be-processed video segment, thereby determining the target coordinates of multiple sampling points in the spherical coordinate system for each video frame.

This application mainly aims to balance the advantages of the Omnidirectional projection and Panini projection models, selecting different projection models under different viewing angles, while ensuring that when different projection models are selected at two adjacent time points during video editing, the intermediate time period can smoothly transition.

S6012. Rendering a corresponding video frame based on the plurality of target coordinates, the first to-be-processed video segment, and the second to-be-processed video segment to generate the first target video segment and the second target video segment.

In some implementations of the present disclosure, after obtaining the target coordinates of multiple sampling points in the corresponding display screen of each video frame, the image processing device can render the pixel points in each video frame onto the display screen based on the plurality of target coordinates to generate the first target video segment and the second target video segment.

In some implementations of the present disclosure, the target coordinates of multiple sampling points in the corresponding display screen of each video frame are determined based on the third projection method corresponding to the first to-be-processed video segment and the fourth projection method corresponding to the second to-be-processed video segment. The target coordinates are determined by smoothly blending the coordinates of each sampling point based on the third projection method and the fourth projection method. Based on the plurality of target coordinates, the first to-be-processed video segment, and the second to-be-processed video segment, the corresponding video frame is rendered to generate the first target video segment and the second target video segment. In this way, since the target coordinates of the sampling points corresponding to each video frame are determined by smoothly blending the coordinates corresponding to two different projection models, when projecting each video frame based on the plurality of target coordinates, the differences between the target coordinates of the sampling points corresponding to each two adjacent video frames are small, which can achieve a smooth transition effect of the projection screen of multiple video frames, reducing the occurrence of large changes in the screen between video segments corresponding to different projection models, and improving the display effect of the first target video segment and the second target video segment.

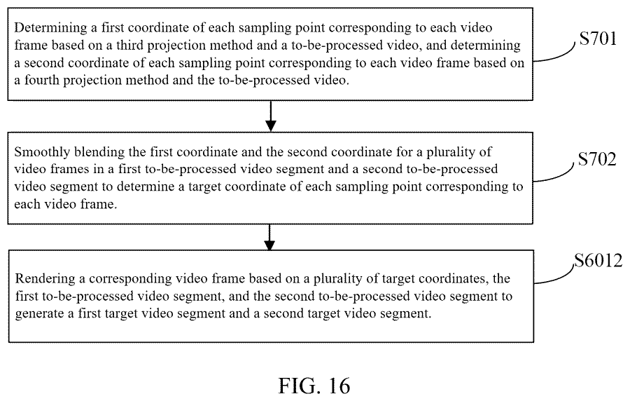

Please refer to FIG. 16, which is a flowchart of the video processing method provided by the present disclosure. S6011 shown in FIG. 15 can also be implemented through S701 to S702, and the method includes:

S701. Determining a first coordinate of each sampling point corresponding to each video frame based on a third projection method and a to-be-processed video, and determining a second coordinate of each sampling point corresponding to each video frame based on a fourth projection method and the to-be-processed video.

In some implementations of the present disclosure, the image processing device can determine the first coordinate based on the third projection method and the coordinates of the to-be-processed sampling points in the to-be-processed video. The image processing device can determine the second coordinate based on the fourth projection method and the coordinates of the to-be-processed sampling points in the to-be-processed video. Each to-be-processed sampling point corresponds one-to-one with a sampling point on the display screen.

In some other implementations, the image processing device can perform back-projection to the panorama based on the third projection method and the coordinates of the to-be-processed sampling points in the to-be-processed video to determine the first coordinate in the spherical coordinate system. The image processing device can perform back-projection to the panorama based on the fourth projection method and the coordinates of the to-be-processed sampling points corresponding to the to-be-processed video segment to determine the second coordinate in the spherical coordinate system.

S702. Smoothly blending the first coordinate and the second coordinate for a plurality of video frames in a first to-be-processed video segment and a second to-be-processed video segment to determine a target coordinate of each sampling point corresponding to each video frame.

In some implementations of the present disclosure, the image processing device smoothly blends the first coordinate and the second coordinate along the sequence of multiple video frames for the plurality of video frames in the first to-be-processed video segment and the second to-be-processed video segment to determine the target coordinate of each sampling point corresponding to each video frame.

The closer the time point of the video frame is to the start time point of the to-be-processed video, the greater the proportion of the first coordinate in forming the target coordinate of the video frame is, and the smaller the proportion of the second coordinate is. Conversely, the closer the time point of the video frame is to the end time point of the to-be-processed video, the greater the proportion of the second coordinate in forming the target coordinate of the video frame is, and the smaller the proportion of the first coordinate is.

In some implementations of the present disclosure, the first coordinate of each sampling point corresponding to each video frame is determined based on the third projection method and the to-be-processed video, and the second coordinate of each sampling point corresponding to each video frame is determined based on the fourth projection method and the to-be-processed video. The first coordinate and the second coordinate are smoothly blended for multiple video frames to determine the target coordinate of each sampling point corresponding to each video frame. In this way, when projecting each video frame based on the plurality of target coordinates, the differences between the target coordinates of the sampling points corresponding to each two adjacent video frames are small, which can achieve a smooth transition effect of the projection screen of multiple video frames, reducing the occurrence of large changes in the screen between video segments corresponding to different projection models, and improving the display effect of the first target video segment and the second target video segment.

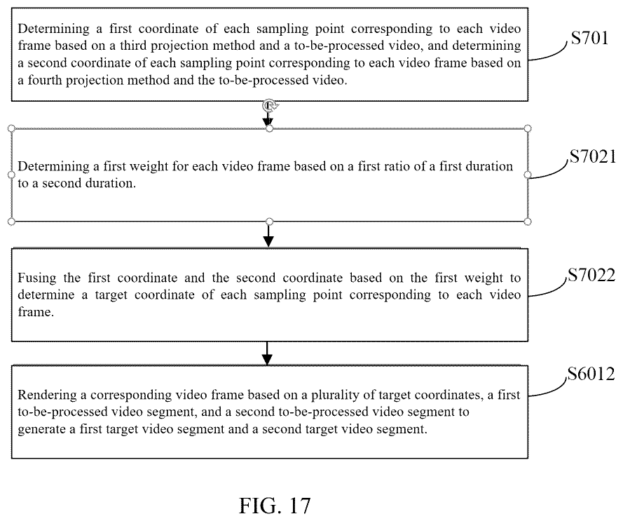

Please refer to FIG. 17, which is a flowchart of the video processing method provided by the present disclosure. S702 shown in FIG. 16 can also be implemented through S7021 to S7022, and the method includes:

S7021. Determining a first weight for each video frame based on a first ratio of a first duration to a second duration.

In some implementations of the present disclosure, the image processing device determines the first duration from the time point corresponding to each video frame to the first time point, and determines the second duration from the second time point to the first time point. The first weight is determined based on the ratio of the first duration to the second duration. The first duration is the duration from the time point corresponding to each video frame to the start time point (first time point) of the to-be-processed video, and the second duration is the duration from the start time point of the to-be-processed video to the end time point (second time point).

In some implementations, a weight curve that smoothly changes from 1 to 0 can be designed for the video frames between the first time point and the second time point. The simplest way to determine the weight is to use a linear change over time, which can determine the first weight weight1 using formula (1).

$$weight 1 = \frac{t - {t}_{1}}{{t}_{2} - {t}_{1}} {t}_{1} \leq t \leq {t}_{2} \qquad ( 1 )$$

In formula (1), t is the time point corresponding to the video frame, t₁ is the first time point, and t₂ is the second time point. The first weight weight1 can be determined based on the difference between t and t₁, divided by the difference between t₂ and t₁. The image processing device determines the weight based on the weight curve and the time t between the two points. When determining the spherical coordinates corresponding to the rendering window's sampling points using the first and second projection methods, spherical linear interpolation is performed for the two spherical coordinates corresponding to each sampling point, with the weight for the spherical coordinates corresponding to the first projection method being 1−weight1, and the weight for the spherical coordinates corresponding to the second projection method being weight1.

S7022. Fusing the first coordinate and the second coordinate based on the first weight to determine a target coordinate of each sampling point corresponding to each video frame.

In some implementations of the present disclosure, the image processing device determines the weight corresponding to the first coordinate by subtracting the first weight from 1, determines the first weight as the weight of the second coordinate, and fuses the first coordinate and the second coordinate based on the weights of the first coordinate and the second coordinate to determine the target coordinate of each sampling point corresponding to each video frame.

In some other implementations, the image processing device can also perform spherical linear interpolation fusion of the first coordinate and the second coordinate based on the weights of the first coordinate and the second coordinate to determine the target coordinate of each sampling point corresponding to each video frame.

In some implementations of the present disclosure, the first weight corresponding to each video frame is determined based on the first ratio of the first duration to the second duration. The first coordinate and the second coordinate are fused based on the first weight to determine the target coordinate of each sampling point corresponding to each video frame. Since the time difference between adjacent video frames is very small, the difference between the first weights corresponding to adjacent video frames is also very small. Therefore, the difference in target coordinates determined by the small difference in the first weight is also very small, resulting in a smooth transition effect of the projection screen of multiple video frames during projection, reducing the occurrence of large changes in the screen between video segments corresponding to different projection models, and improving the display effect of the first target video segment and the second target video segment.

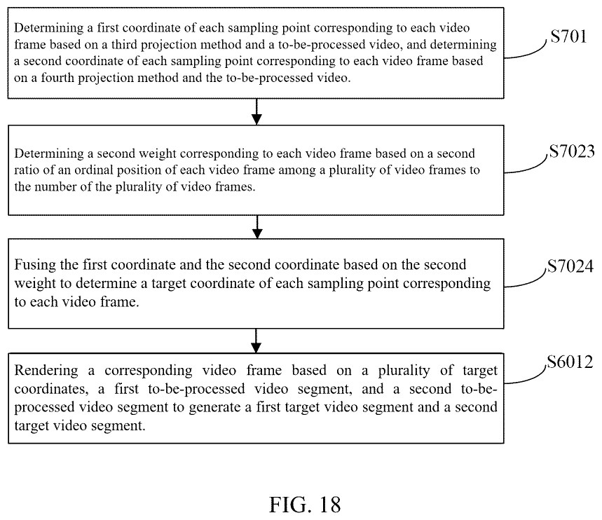

Please refer to FIG. 18, which is a flowchart of the video processing method provided by the present disclosure. S702 shown in FIG. 16 can also be implemented through S7023 to S7024, and the method includes:

S7023. Determining a second weight corresponding to each video frame based on a second ratio of an ordinal position of each video frame among a plurality of video frames to the number of the plurality of video frames.

In some implementations of the present disclosure, the number of multiple video frames in the to-be-processed video can be N. N is an integer greater than 0. The image processing device determines the second weight corresponding to each video frame by dividing the ordinal position of each video frame by N.

In some implementations, the second weight weight2 can be determined using formula (2).

$$weight 2 = \frac{M}{N} \qquad ( 2 )$$

where M is the ordinal position of each video frame among the plurality of video frames, and N is the number of the plurality of video frames. M divided by N can determine the second weight weight2.

S7024. Fusing the first coordinate and the second coordinate based on the second weight to determine a target coordinate of each sampling point corresponding to each video frame.

In some implementations of the present disclosure, the image processing device determines the weight corresponding to the first coordinate by subtracting the second weight from 1, determines the second weight as the weight of the second coordinate, and fuses the first coordinate and the second coordinate based on the weights of the first coordinate and the second coordinate to determine the target coordinate of each sampling point corresponding to each video frame.

In some other implementations, the image processing device can also perform spherical linear interpolation fusion of the first coordinate and the second coordinate based on the weights of the first coordinate and the second coordinate to determine the target coordinate of each sampling point corresponding to each video frame.

In some implementations of the present disclosure, the second weight corresponding to each video frame is determined based on the second ratio of the ordinal position of each video frame among the plurality of video frames to the number of the plurality of video frames. The first coordinate and the second coordinate are fused based on the second weight to determine the target coordinate of each sampling point corresponding to each video frame. Since the ordinal positions of adjacent video frames are continuous, the difference between the second weights corresponding to adjacent video frames is also very small. Therefore, the difference in target coordinates determined by the small difference in the second weight is also very small, resulting in a smooth transition effect of the projection screen of multiple video frames during projection, reducing the occurrence of large changes in the screen between video segments corresponding to different projection models, and improving the display effect of the first target video segment and the second target video segment.

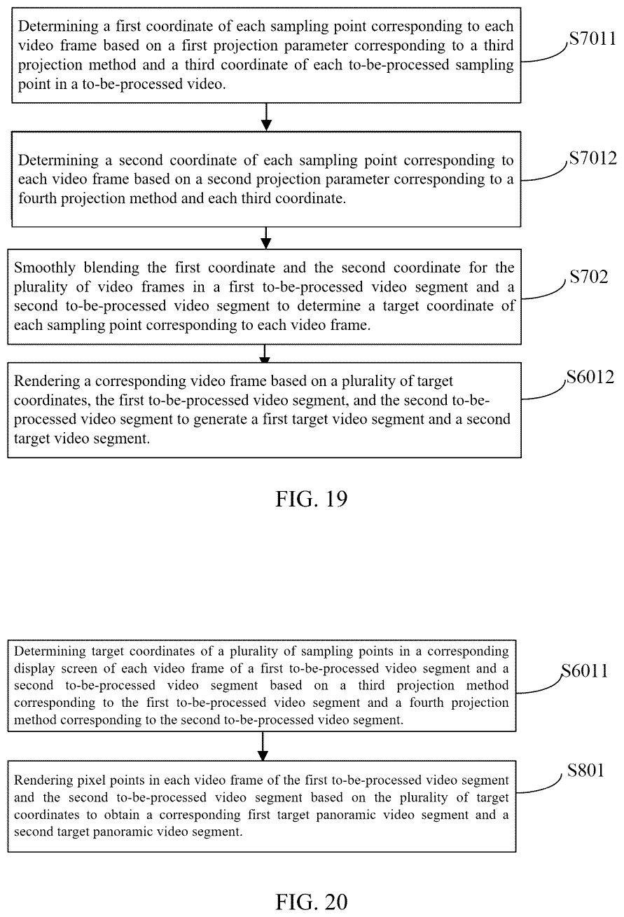

Please refer to FIG. 19, which is a flowchart of the video processing method provided by the present disclosure. S701 shown in FIG. 16 can also be implemented through S7011 to S7012, and the method includes:

S7011. Determining the first coordinate of each sampling point corresponding to each video frame based on the first projection parameter corresponding to the third projection method and the third coordinate of each to-be-processed sampling point in the to-be-processed video.

In some implementations of the present disclosure, the image processing device can determine the first coordinate of each sampling point corresponding to each video frame based on the first projection parameter corresponding to the third projection method and the third coordinate of each to-be-processed sampling point in the to-be-processed video. When the third projection method is the Panini projection method, the first projection parameter can include: projection center offset distance, crop adaptation, and field of view size.

In some implementations of the present disclosure, the image processing device can back-project each to-be-processed sampling point's third coordinate in the to-be-processed video segment to the panorama based on the projection center offset distance, crop adaptation, and field of view size corresponding to the third projection method, determining the first coordinate of each sampling point corresponding to each video frame in the spherical coordinate system.

S7012. Determining a second coordinate of each sampling point corresponding to each video frame based on a second projection parameter corresponding to a fourth projection method and each third coordinate.

In some implementations of the present disclosure, the image processing device can determine the second coordinate of each sampling point corresponding to each video frame based on the second projection parameter corresponding to the fourth projection method and each third coordinate in the to-be-processed video segment.

In some implementations of the present disclosure, the image processing device can back-project each to-be-processed sampling point's third coordinate in the to-be-processed video segment to the panorama based on the second projection parameter corresponding to the fourth projection method, determining the second coordinate of each sampling point corresponding to each video frame in the spherical coordinate system.

In some implementations of the present disclosure, the first coordinate of each sampling point corresponding to each video frame is determined based on the first projection parameter corresponding to the third projection method and the third coordinate of each to-be-processed sampling point in the to-be-processed video. The second coordinate of each sampling point corresponding to each video frame is determined based on the second projection parameter corresponding to the fourth projection method and each third coordinate. Since the target coordinate of each sampling point corresponding to each video frame is determined by smoothly blending the first coordinate and the second coordinate, when projecting each video frame based on the plurality of target coordinates, the differences between the target coordinates of the sampling points corresponding to each two adjacent video frames are small, which can achieve a smooth transition effect of the projection screen of multiple video frames, reducing the occurrence of large changes in the screen between video segments corresponding to different projection models, and ensuring that the projected video frames still have the characteristics of the corresponding projection method to some extent.

Please refer to FIG. 20, which is a flowchart of the video processing method provided by the present disclosure. S6012 shown in FIG. 15 can also be implemented through S801, and the method includes:

S801. Rendering pixel points in each video frame of the first to-be-processed video segment and the second to-be-processed video segment based on the plurality of target coordinates to obtain a corresponding first target panoramic video segment and a second target panoramic video segment.

In some implementations of the present disclosure, the target coordinates can be the coordinates of each sampling point corresponding to each video frame in the spherical coordinate system. The image processing device can render the pixel points in each video frame onto the display screen based on the plurality of target coordinates to obtain the corresponding first target panoramic video segment and the second target panoramic video segment.

In some implementations of the present disclosure, the pixel points in each video frame are projected onto the display screen based on the plurality of target coordinates to obtain the corresponding first target panoramic video segment and the second target panoramic video segment. Since the first target panoramic video segment and the second target panoramic video segment are generated based on the user's expected angles of view, and the line features in the first target panoramic video segment and the second target panoramic video segment corresponding to different expected angles of view are different, the panoramic video corresponding to different expected angles of view has different projection screens. Therefore, compared to the related technology where different images are projected using the same projection method, this solves the problem of a single image projection angle of view, allowing the projection effect to meet the user's expectations and improving the display effect of the first target panoramic video segment and the second target panoramic video segment.

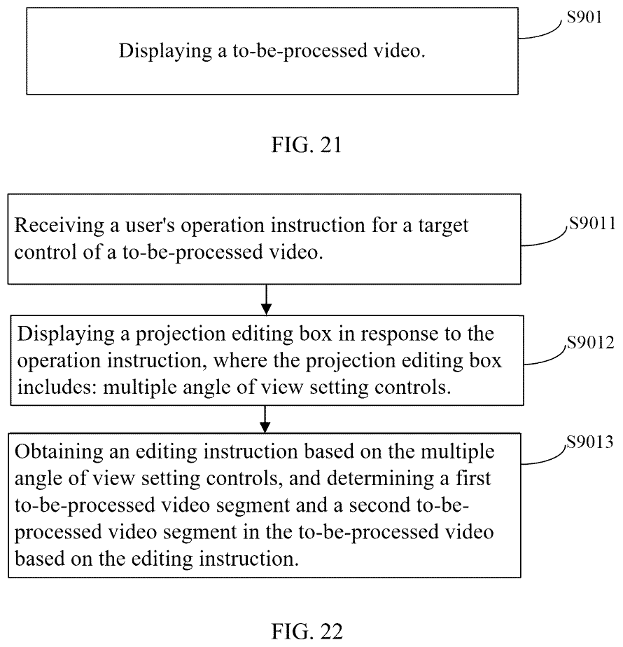

Please refer to FIG. 21, which is a flowchart of the video processing method provided by the present disclosure. Before S501 shown in FIG. 13, S901 can also be included, and the method includes:

S901. Displaying a to-be-processed video.

In some implementations of the present disclosure, the image processing device displays the to-be-processed video. The image processing device can determine the first to-be-processed video segment and the second to-be-processed video segment in the to-be-processed video based on the user's operation instruction.

In some other implementations, the image processing device can determine the first to-be-processed video segment or the second to-be-processed video segment located between two time points in the to-be-processed video based on the user's operation instruction.

In some implementations of the present disclosure, the image processing device displays the to-be-processed video, facilitating the user to select the corresponding first to-be-processed video segment and the second to-be-processed video segment based on the time points on the to-be-processed video.

Please refer to FIG. 22, which is a flowchart of the video processing method provided by the present disclosure. The method includes:

S9011. Receiving a user's operation instruction for the target control of a to-be-processed video.

In some implementations of the present disclosure, the image processing device can import the to-be-processed video into editing software. The editing software interface on the image processing device includes a target control, and the user can click the target control to perform video editing on the to-be-processed video.

S9012. Displaying a projection editing box in response to the operation instruction, where the projection editing box includes: multiple angle of view setting controls.

In some implementations of the present disclosure, the image processing device displays a rendering editing box in response to the user's operation instruction. The rendering editing box includes multiple angle of view setting controls. The user can input the required longitudinal angle of view for each angle of view setting control.

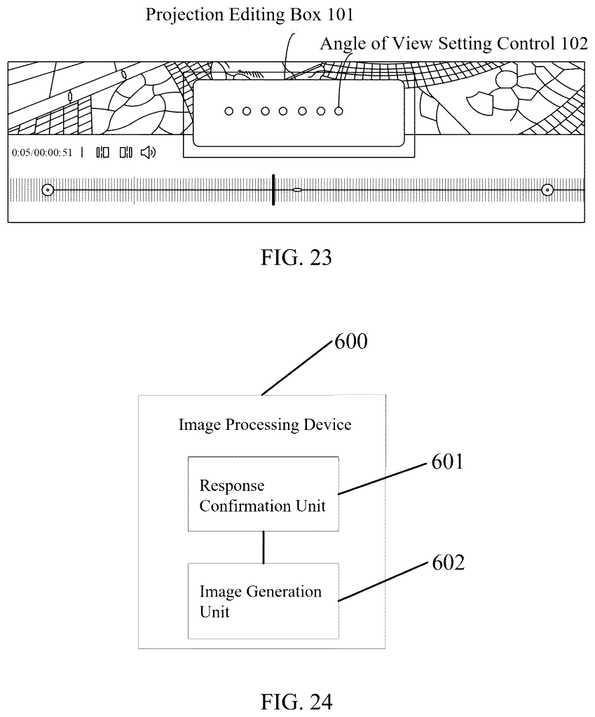

In some implementations, referring to FIG. 23, the projection editing box 101 includes multiple angle of view setting controls 102, each angle of view setting control 102 can be used to set different angles of view. If the user clicks the control corresponding to the longitudinal angle of view, they can set the required longitudinal expected angle of view.

S9013. Obtaining an editing instruction based on the multiple angle of view setting controls, and determining a first to-be-processed video segment and a second to-be-processed video segment in the to-be-processed video based on the editing instruction.

In some implementations of the present disclosure, after setting the required expected angle of view, the user can determine the position points in the progress bar, and based on the determined time points corresponding to each two position points, determine the video as the first to-be-processed video segment or the second to-be-processed video segment.

In some implementations of the present disclosure, the user's operation instruction for the target control of the to-be-processed video is received. In response to the operation instruction, a rendering editing box is displayed, where the rendering editing box includes: multiple angle of view setting controls. An editing instruction is obtained based on the multiple angle of view setting controls, and the first to-be-processed video segment and the second to-be-processed video segment are determined in the to-be-processed video based on the editing instruction. In this way, the user can select the corresponding video segment to be displayed based on the angle of view setting controls corresponding to different angles of view, facilitating user operation, allowing the user to accurately select the first to-be-processed video segment and the second to-be-processed video segment corresponding to different expected angles of view in the to-be-processed video frames.

Please refer to FIG. 24, which is a schematic structural diagram of the image processing device provided by the present disclosure. The structure includes the following.

The implementations of the present disclosure also provide an image processing device 600, including: a response confirmation unit 601 and an image generation unit 602.

The response confirmation unit 601 is used to confirm the expected angle of view of the to-be-processed image in response to detecting a user's interactive operation.

The image generation unit 602 is used to generate a target image based on the to-be-processed image and the expected angle of view of the to-be-processed image, where the line feature of the target image corresponds to the expected angle of view of the to-be-processed image.

In some implementations of the present disclosure, the expected angle of view includes a longitudinal expected angle of view, the to-be-processed image includes a first to-be-processed image, and the target image includes a first target image obtained by performing image processing on the to-be-processed image. The image generation unit 602 in the image processing device 600 is used to generate the first target image when the longitudinal expected angle of view of the first to-be-processed image is not greater than the first angle of view threshold, along the vertical direction of their respective corresponding display screens, one or more first lines have greater curvature than the corresponding second lines. The first line is a line of the first to-be-processed image, and the second line is a line of the first target image, with a corresponding relationship between the first line and the second line.

In some implementations of the present disclosure, along the vertical direction of their respective corresponding display screens, the first line is displayed as a curve, and the second line is displayed as a vertical straight line.

In some implementations of the present disclosure, the first to-be-processed image and the first target image have at least one or more combinations of the following features:

A plurality of first lines along the vertical direction in the first to-be-processed image are displayed as vertical second lines in the first target image.

The curvature of a plurality of first radial lines in the first to-be-processed image is consistent with the curvature of a plurality of second radial lines corresponding to the plurality of first radial lines in the first target image.

The curvature of a curve along the horizontal direction in the first to-be-processed image is less than the curvature of a curve along the horizontal direction in the first target image.

In some implementations of the present disclosure, the first line and the second line correspond, including: the display screen formed by the plurality of first lines is substantially the same as the display screen formed by the plurality of second lines.

In some implementations of the present disclosure, the image generation unit 602 in the image processing device 600 is used to generate the first target image based on the first to-be-processed image and the first projection method when the longitudinal expected angle of view is not greater than the first angle of view threshold.

The first projection method causes, along the vertical direction of their respective corresponding display screens, one or more first lines to have greater curvature than the corresponding second lines.

In some implementations of the present disclosure, the expected angle of view includes a horizontal expected angle of view, and the horizontal expected angle of view of the first to-be-processed image is greater than or equal to the second angle of view threshold. The second angle of view threshold is greater than the first angle of view threshold.

In some implementations of the present disclosure, the to-be-processed image includes a second to-be-processed image, and the target image includes a second target image obtained by performing image processing on the second to-be-processed image. The longitudinal expected angle of view of the second to-be-processed image is not less than the third angle of view threshold, and the image generation unit 602 in the image processing device 600 is used to generate the second target image when the longitudinal expected angle of view of the second to-be-processed image is not less than the third angle of view threshold, and the line feature of the second target image is different from the line feature of the first target image, where the third angle of view threshold is greater than or equal to the first angle of view threshold.

In some implementations of the present disclosure, along the vertical direction of their respective corresponding display screens, one or more third lines have less curvature than the corresponding fourth lines, where the third line is a line of the second to-be-processed image, and the fourth line is a line of the second target image, with a corresponding relationship between the third line and the fourth line.

In some implementations of the present disclosure, the image generation unit 602 in the image processing device 600 is used to generate the second target image based on the second to-be-processed image and the second projection method when the longitudinal expected angle of view of the second to-be-processed image is not less than the third angle of view threshold.

The second projection method causes, along the vertical direction of their respective corresponding display screens, one or more third lines to have less curvature than the corresponding fourth lines.

In some implementations of the present disclosure, the image generation unit 602 in the image processing device 600 is used to determine the effect selected by the user when the screen is displayed in a horizontal manner, and process the second to-be-processed image into the second target image when the effect is a crystal ball effect or a small planet effect.

In some implementations of the present disclosure, the expected angle of view represents an angle of view corresponding to a screen in a viewfinder image for generating a target image.

In some implementations of the present disclosure, the target image is a preview image when a capturing device captures an image; and the response confirmation unit 601 in the image processing device 600 is used to confirm the preview screen display ratio selected by the user in response to detecting a user's interactive operation.

The expected angle of view is confirmed based on the preview screen display ratio selected by the user.

In some implementations of the present disclosure, the response confirmation unit 601 in the image processing device 600 is used to confirm that the to-be-processed image is the first to-be-processed image when the ratio of the width to the height of the preview screen is the first ratio, and the longitudinal expected angle of view of the first to-be-processed image is not greater than the first angle of view threshold.

When the ratio of the width to the height of the preview screen is the second ratio, it is confirmed that the to-be-processed image is the second to-be-processed image, and the longitudinal expected angle of view of the second to-be-processed image is not less than the third angle of view threshold, where the first ratio is greater than the second ratio.

In some implementations of the present disclosure, the line feature includes one of the following features:
the curvature of a vertical line of the captured image in the target image; and
the curvature of a horizontal line of the captured image in the target image.

It should be noted that in some implementations of the present disclosure, if the above image processing method is implemented in the form of a software function module and sold or used as an independent product, it can also be stored in a computer-readable storage medium. Based on this understanding, the technical solutions of some implementations of the present disclosure can essentially be embodied as a software product, which is stored in a storage medium and includes several instructions to enable an image processing device (which can be a personal computer, etc.) to execute all or part of the methods described in some implementations of the present disclosure. The aforementioned storage medium includes: Universal Serial Bus (USB) flash drives, mobile hard drives, read-only memory (ROM), magnetic disks, or optical discs, etc., which can store program code. In this way, some implementations of the present disclosure are not limited to any specific combination of hardware and software.

Correspondingly, some implementations of the present disclosure provide a computer-readable storage medium on which a computer program is stored. When the computer program is executed by a processor, it implements the operations in the method of the image processing device.

It should be noted here: the description of the above storage medium and device implementations is similar to the description of the above method implementations and has similar beneficial effects to the method implementations. For technical details not disclosed in the storage medium and device implementations of the present disclosure, please refer to the description of the method implementations of the present disclosure for understanding.

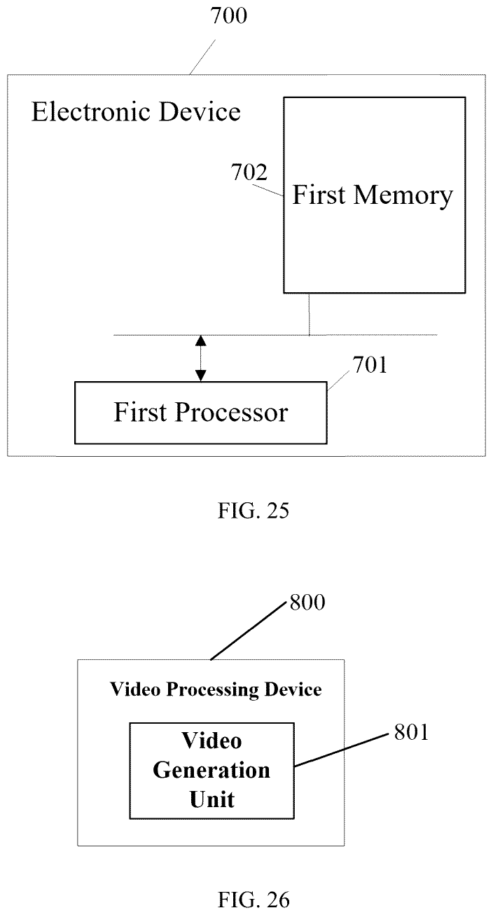

It should be noted that FIG. 25 is a schematic diagram of a hardware entity of an electronic device provided by the implementation of the present disclosure. The electronic device 700 includes electronic components for implementing the operations in the image processing device method. The physical structure of the electronic device 700 includes: a first memory 702 and a first processor 701. The first memory 702 stores a computer program that can run on the first processor 701, and the first processor 701 executes the program to implement the operations in the image processing device method.

As shown in FIG. 25, the hardware entity of the electronic device 700 includes: a first processor 701 and a first memory 702, where the first processor 701 generally controls the overall operation of the electronic device 700.

The first memory 702 is configured to store instructions and applications executable by the first processor 701, and can also cache data to be processed or already processed by the first processor 701 and various modules in the electronic device 700 (e.g., image data, audio data, voice communication data, and video communication data), which can be implemented through flash memory (FLASH) or random access memory (RAM).

Correspondingly, the present disclosure implementation also provides a computer program product, including a computer program, which can be executed by the first processor 701 of the electronic device 700 to complete the operations in the image processing device method.

Please refer to FIG. 26, which is a schematic structural diagram of the video processing device provided by the present disclosure implementation.

One implementation of the present disclosure also provides a video processing device 800, including: a video generation unit 801.

The video generation unit 801 is used to generate a target video based on the to-be-processed video, where the video frames of the to-be-processed video include the to-be-processed image in the image processing method, and the video frames of the target video include the target image in the image processing method.

In the present disclosure implementation, the to-be-processed video includes a first to-be-processed video segment and a second to-be-processed video segment, and the target video includes a first target video segment and a second target video segment.

The expected angle of view of the first to-be-processed video segment is different from the expected angle of view of the second to-be-processed video segment.

The line feature of the first target video segment is different from the line feature of the second target video segment.

In the present disclosure implementation, the video generation unit 801 in the video processing device 800 is used to generate the first target video segment and the second target video segment based on the first to-be-processed video segment and the second to-be-processed video segment to smooth the transition of the first target video segment and the second target video segment.

In the present disclosure implementation, the first target video segment is obtained based on the first to-be-processed video segment via a third projection method, and the third projection method causes, along the vertical direction of their respective corresponding display screens, one or more first lines to have greater curvature than the corresponding second lines;

The second target video segment is obtained based on the second to-be-processed video segment via a fourth projection method, and the fourth projection method is different from the third projection method.

In the present disclosure implementation, the video generation unit 801 in the video processing device 800 is used to determine the target coordinate of a plurality of sampling points in the corresponding display screen of each video frame of the first to-be-processed video segment and the second to-be-processed video segment based on the third projection method corresponding to the first to-be-processed video segment and the fourth projection method corresponding to the second to-be-processed video segment.

The target coordinate is determined by smoothly blending the coordinates of each sampling point based on the third projection method and the fourth projection method.

Rendering the corresponding video frames based on the plurality of target coordinates, the first to-be-processed video segment, and the second to-be-processed video segment to generate the first target video segment and the second target video segment.

In the present disclosure implementation, the video generation unit 801 in the video processing device 800 is used to determine the first coordinate of each sampling point corresponding to each video frame based on the third projection method and the to-be-processed video, and determine the second coordinate of each sampling point corresponding to each video frame based on the fourth projection method and the to-be-processed video.

Smoothly blending the first coordinate and the second coordinate for the plurality of video frames in the first to-be-processed video segment and the second to-be-processed video segment to determine the target coordinate of each sampling point corresponding to each video frame.

In the present disclosure implementation, the video generation unit 801 in the video processing device 800 is used to determine the first weight corresponding to each video frame based on the first ratio of the first duration to the second duration, where the first duration is the duration from the time point corresponding to each video frame to the start time point of the to-be-processed video, and the second duration is the duration from the start time point of the to-be-processed video to the end time point.

The first coordinate and the second coordinate are fused based on the first weight to determine the target coordinate of each sampling point corresponding to each video frame.

In the present disclosure implementation, the video generation unit 801 in the video processing device 800 is used to determine the second weight corresponding to each video frame based on the second ratio of the ordinal position of each video frame among the plurality of video frames to the number of the plurality of video frames.

The first coordinate and the second coordinate are fused based on the second weight to determine the target coordinate of each sampling point corresponding to each video frame.

In the present disclosure implementation, the video generation unit 801 in the video processing device 800 is used to determine the first coordinate of each sampling point corresponding to each video frame based on the first projection parameter corresponding to the third projection method and the third coordinate of each to-be-processed sampling point in the to-be-processed video.

The second coordinate of each sampling point corresponding to each video frame is determined based on the second projection parameter corresponding to the fourth projection method and each third coordinate.

In the present disclosure implementation, the video generation unit 801 in the video processing device 800 is used to render the pixel points in each video frame of the first to-be-processed video segment and the second to-be-processed video segment based on the plurality of target coordinates to obtain the corresponding first target panoramic video segment and the second target panoramic video segment.

In the present disclosure implementation, the video processing device 800 is used to display the to-be-processed video.

In the present disclosure implementation, the video processing device 800 is used to receive a user's operation instruction for the target control of the to-be-processed video.

In response to the operation instruction, a projection editing box is displayed, where the projection editing box includes: multiple angle of view setting controls.

An editing instruction is obtained based on the multiple angle of view setting controls, and the first to-be-processed video segment and the second to-be-processed video segment in the to-be-processed video are determined based on the editing instruction.

In the present disclosure implementation, the target video is a preview screen of a capturing device.

Correspondingly, the present disclosure implementation provides a computer-readable storage medium on which a computer program is stored. When the computer program is executed by a processor, it implements the operations in the image processing device method.

It should be noted here: the description of the above storage medium and device implementations is similar to the description of the above method implementations and has similar beneficial effects to the method implementations. For technical details not disclosed in the storage medium and device implementations of the present disclosure, please refer to the description of the method implementations of the present disclosure for understanding.

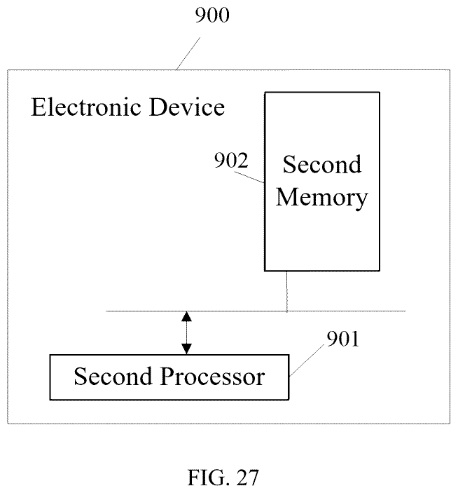

It should be noted that FIG. 27 is a schematic diagram of a hardware entity of an electronic device provided by the implementation of the present disclosure. The electronic device 900 includes electronic components for implementing the operations in the video processing device method. The physical structure of the electronic device 900 includes: a second memory 902 and a second processor 901. The second memory 902 stores a computer program that can run on the second processor 901, and the second processor 901 executes the program to implement the operations in the image processing device method.

As shown in FIG. 27, the hardware entity of the electronic device 900 includes: a second processor 901 and a second memory 902.

The second processor 901 generally controls the overall operation of the electronic device 900.

The second memory 902 is configured to store instructions and applications executable by the second processor 901, and can also cache data to be processed or already processed by the second processor 901 and various modules in the electronic device 900 (e.g., image data, audio data, voice communication data, and video communication data), which can be implemented through flash memory (FLASH) or random access memory (RAM).

Correspondingly, the present disclosure implementation also provides a computer program product, including a computer program, which can be executed by the second processor 901 of the electronic device 900 to complete the operations in the video processing device method.

In some implementations of the present disclosure, the image processing device can process the first to-be-processed image so that one or more first lines along the vertical direction of the display screen in the first to-be-processed image become second lines with reduced curvature after processing, thereby forming a first target image projected on the display screen. In this way, when the obtained longitudinal angle of view is not greater than the first angle of view threshold, the first to-be-processed image is projected as the first target image, which can make the first target image's display more in line with the user's projection expectations compared to using only one projection method in the related technology. Moreover, the first lines in the first to-be-processed image, after being processed by the image processing device, are displayed as second lines with smaller curvature in the first target image, reducing the distortion of the image along the vertical direction and improving the display effect of the first target image.

In some implementations of the present disclosure, a plurality of first lines along the vertical direction in the first to-be-processed image are displayed as vertical second lines in the first target image, and the curvature of a first radial line in the first to-be-processed image is consistent with the curvature of a second radial line in the first target image, and the curvature of a curve along the horizontal direction in the first to-be-processed image is less than the curvature of a curve along the horizontal direction in the first target image. In this way, after the first to-be-processed image is processed by the image processing device, the first lines along the vertical direction are displayed as second lines with smaller curvature in the first target image, and the curvature of a first radial line in the to-be-processed image is consistent with the curvature of a second radial line in the first target image, which can ensure that while reducing the curvature of the first to-be-processed image in the vertical direction, the distortion degree of the radial image in the first target image is also reduced.

It should be understood that throughout the specification, the term “one implementation” or “an implementation” means that a particular feature, structure, or characteristic described in connection with the implementation is included in at least one implementation of the present disclosure. Therefore, the appearances of “in one implementation” or “in an implementation” in various places throughout the specification are not necessarily all referring to the same implementation. Furthermore, the particular features, structures, or characteristics may be combined in any suitable manner in one or more implementations. It should be understood that in various implementations of the present disclosure, the sequence numbers of the above processes do not imply the order of execution. The execution order of the processes should be determined by their functions and intrinsic logic, and should not constitute any limitation on the implementation process of some implementations of the present disclosure. The sequence numbers of the above implementations are only for description and do not represent the merits of some implementations.

It should be noted that the terms “comprises,” “includes,” or any other variations thereof are intended to cover a non-exclusive inclusion, such that a process, method, article, or device that includes a list of elements not only includes those elements but may also include other elements not explicitly listed, or elements inherent to such process, method, article, or device. Without further limitation, an element defined by the phrase “comprising a . . . ” does not preclude the presence of additional identical elements in the process, method, article, or device that includes the element.

In several implementations provided by the present disclosure, it should be understood that the disclosed devices and methods can be implemented in other ways. The device implementations described above are merely illustrative. For example, the division of units is merely a logical function division, and there may be other division methods in actual implementation, such as multiple units or components can be combined, or can be integrated into another system, or some features can be ignored, or not executed. In addition, the coupling, direct coupling, or communication connection between the components shown or discussed can be through some interfaces, indirect coupling, or communication connection of devices or units, which can be electrical, mechanical, or other forms.

The units described as separate components above may or may not be physically separated, and components shown as units may or may not be physical units; they can be located in one place or distributed across multiple network units; some or all of the units can be selected according to actual needs to achieve the objectives of this implementation.

In addition, the functional units in each implementation of the present disclosure can all be integrated into one processing unit, or each unit can be separately as a single unit, or two or more units can be integrated into one unit; the integrated unit can be implemented in hardware form or in hardware plus software functional units.

Those skilled in the art can understand that all or part of the operations of the above method implementations can be completed by hardware related to program instructions, and the aforementioned program can be stored in a computer-readable storage medium. When executed, the program executes the operations of the above method implementations; and the aforementioned storage medium includes: mobile storage devices, read-only memory (ROM), magnetic disks, or optical discs, etc., which can store program code.

Alternatively, if the integrated unit described above in the present disclosure is implemented in the form of a software function module and sold or used as an independent product, it can also be stored in a computer-readable storage medium. Based on this understanding, the technical solutions of some implementations of the present disclosure can essentially be embodied as software products, which are stored in a storage medium and include several instructions to enable a computer device (which can be a personal computer, server, or network device, etc.) to execute all or part of the methods described in some implementations of the present disclosure. The aforementioned storage medium includes: mobile storage devices, ROM, magnetic disks, or optical discs, etc., which can store program code.

The above description is only an implementation of the present disclosure, but the protection scope of the present disclosure is not limited to this. Any changes or substitutions that can be easily thought of by those skilled in the art within the technical scope disclosed in the present disclosure should be covered within the protection scope of the present disclosure. Therefore, the protection scope of the present disclosure should be subject to the protection scope of the claims.

What is claimed is:

1. An image processing method, comprising:
confirming an expected angle of view of a to-be-processed image in response to detection of an interactive operation by a user; and
generating a target image based on the to-be-processed image and the expected angle of view of the to-be-processed image, wherein a line feature of the target image corresponds to the expected angle of view of the to-be-processed image.

2. The image processing method according to claim 1, wherein:
the expected angle of view comprises a longitudinal expected angle of view, the to-be-processed image comprises a first to-be-processed image, and the target image comprises a first target image obtained by performing image processing on the first to-be-processed image; and
when the longitudinal expected angle of view of the first to-be-processed image is equal to or less than a first angle of view threshold, one or more first lines are curved to a greater extent than a corresponding second line along a vertical direction of a respective corresponding display screen, the first line being a line of the first to-be-processed image, the second line being a line of the first target image, and the first line corresponding to the second line.

3. The image processing method according to claim 2, wherein along the vertical direction of the respective corresponding display screen, the first line is displayed as a curve and the second line is displayed as a vertical straight line.

4. The image processing method according to claim 2, wherein the first to-be-processed image and the first target image have at least one of features comprising:
a plurality of first vertical lines along a vertical direction in the first to-be-processed image are displayed as a plurality of second lines that are vertical in the first target image;
curvature of a plurality of first radial lines along a horizontal direction in the first to-be-processed image is consistent with curvature of a plurality of second radial lines corresponding to the plurality of first radial lines in the first target image; or
curvature of a curve along a horizontal direction in the first to-be-processed image is less than curvature of a curve along the horizontal direction in the first target image.

5. The image processing method according to claim 2, wherein:
the first line and the second line correspond to each other, and a correspondence of the first line and the second line establishes a display screen formed by the one or more first lines being substantially identical to a display screen formed by the one or more second lines.

6. The image processing method according to claim 2, wherein generating the target image based on the to-be-processed image and the expected angle of view of the to-be-processed image comprises:
when the longitudinal expected angle of view is equal to or less than the first angle of view threshold, generating the first target image based on the first to-be-processed image and a first projection method; and
the first projection method causes, along a vertical direction of the respective corresponding display screen, the one or more first lines to be curved to a greater extent than the corresponding second lines.

7. The image processing method according to claim 6, wherein the expected angle of view comprises a horizontal expected angle of view, the horizontal expected angle of view of the first to-be-processed image being greater than or equal to a second angle of view threshold; and
wherein the second angle of view threshold is greater than the first angle of view threshold.

8. The image processing method according to claim 2, wherein:
the to-be-processed image comprises a second to-be-processed image, and the target image comprises a second target image obtained by performing image processing on the second to-be-processed image; and
when the longitudinal expected angle of view of the second to-be-processed image is equal to or greater than a third angle of view threshold, a line feature of the second target image is different from a line feature of the first target image, and the third angle of view threshold is greater than or equal to the first angle of view threshold.

9. The image processing method according to claim 1, wherein the expected angle of view represents an angle of view corresponding to a screen in a viewfinder image for generating a target image.

10. The image processing method according to claim 1, wherein the target image is a preview image when a capturing device captures an image, and confirming an expected angle of view of a to-be-processed image in response to detection of an interactive operation by a user comprises:
confirming a preview screen display ratio selected by a user in response to detection of the interactive operation by the user; and
confirming the expected angle of view based on the preview screen display ratio selected by the user.

11. The image processing method according to claim 1, wherein the line feature comprises one of features comprising:
curvature of a vertical line of a captured image in the target image; or
curvature of a horizontal line of the captured image in the target image.

12. A video processing method, comprising:
generating a target video based on a to-be-processed video, wherein:
frames of the to-be-processed video comprise a to-be-processed image where an expected angle of view of the to-be-processed image is confirmed in response to detection of an interactive operation by a user; and
frames of the target video comprise a target image that is generated based on the to-be-processed image and the expected angle of view of the to-be-processed image, wherein a line feature of the target image corresponds to the expected angle of view of the to-be-processed image.

13. The video processing method according to claim 12, wherein:
the to-be-processed video comprises a first to-be-processed video segment and a second to-be-processed video segment, and the target video comprises a first target video segment and a second target video segment;
an expected angle of view of the first to-be-processed video segment is different from an expected angle of view of the second to-be-processed video segment; and
a line feature of the first target video segment is different from a line feature of the second target video segment.

14. The video processing method according to claim 13, wherein generating the target video based on the to-be-processed video comprises:
generating the first target video segment and the second target video segment based on the first to-be-processed video segment and the second to-be-processed video segment, to smooth a transition of the first target video segment and the second target video segment.

15. The video processing method according to claim 13, wherein:
the first target video segment is obtained based on the first to-be-processed video segment via a third projection method, and the third projection method causes, along a vertical direction of a corresponding display screen, the one or more first lines to be curved to a greater extent than the corresponding second lines; and
the second target video segment is obtained based on the second to-be-processed video segment via a fourth projection method, and the fourth projection method is different from the third projection method.

16. The video processing method according to claim 15, wherein generating the first target video segment and the second target video segment based on the first to-be-processed video segment and the second to-be-processed video segment comprises:
determining a target coordinate of a plurality of sampling points in a corresponding display screen of each video frame of the first to-be-processed video segment and the second to-be-processed video segment based on the third projection method corresponding to the first to-be-processed video segment and the fourth projection method corresponding to the second to-be-processed video segment, wherein the target coordinate is smoothly determined through blending coordinates of each of the sampling points based on the third projection method and the fourth projection method; and
rendering a corresponding video frame based on the plurality of target coordinates, the first to-be-processed video segment, and the second to-be-processed video segment to generate the first target video segment and the second target video segment.

17. The video processing method according to claim 16, wherein determining the target coordinate of the plurality of sampling points in the corresponding display screen of each video frame of the first to-be-processed video segment and the second to-be-processed video segment based on the third projection method corresponding to the first to-be-processed video segment and the fourth projection method corresponding to the second to-be-processed video segment comprises:
determining a first coordinate of each of the sampling points corresponding to each of the video frames based on the third projection method and the to-be-processed video, and determining a second coordinate of each of the sampling points corresponding to each of the video frames based on the fourth projection method and the to-be-processed video; and smoothly blending the first coordinate and the second coordinate for the plurality of video frames in the first to-be-processed video segment and the second to-be-processed video segment to determine the target coordinate of each of the sampling points corresponding to each of the video frames.

18. The video processing method according to claim 12, further comprising: displaying the to-be-processed video before generating the target video based on the to-be-processed video.

19. The video processing method according to claim 12, wherein the target video is a preview image of a capturing device.

20. An electronic device, comprising a storage and a processor, wherein the storage stores a computer program capable of running on the processor, and the processor, when executing the computer program, is configured to implement:
confirming an expected angle of view of a to-be-processed image in response to detection of an interactive operation by a user; and
generating a target image based on the to-be-processed image and the expected angle of view of the to-be-processed image, wherein a line feature of the target image corresponds to the expected angle of view of the to-be-processed image.
